(19) United States
(12) Patent Application Publication
(10) Pub. No.: US 2022/0264532 A1
(43) Pub. Date: Aug. 18, 2022

(54) LOCATION DETERMINATION RESOURCE ALLOCATION

(71) Applicant: IPCOM GMBH & CO. KG, Pullach (DE)

(72) Inventors: Maik BIENAS, Schoeppenstedt (DE); Martin HANS, Bad Salzdetfurth (DE)

(73) Assignee: IPCOM GMBH & CO. KG, Pullach (DE)

(21) Appl. No.: 17/597,779

(22) PCT Filed: Aug. 6, 2020
(86) PCT No.: PCT/EP2020/072151

§ 371 Date: Jan. 22, 2022

(30) Foreign Application Priority Data
Aug. 6, 2019 (EP) 19190176.8

(51) Int. Cl. H04W 72/02; H04W 72/04; G01S 5/00; H04W 64/00

(52) U.S. Cl. CPC H04W 72/02; H04W 72/048; H04W 64/003; G01S 5/0063; H04W 72/0446

(57) ABSTRACT

The invention provides a method of allocating radio resources for the transmission of radio signals for determining a distance between a first station and a second station by transmitting a first signal in a first direction from the first station to the second station and a second, response signal in a second direction from the second station to the first station after a reception of the first signal at the second station, wherein a selection of a timing of the radio resources is made using a predetermined measurement of a distance between the first station and the second station.

The present invention relates to a technique for allocating radio spectrum resources for the transmission of signals used in location determination.

A broad variety of methods are known to measure or estimate the distance between a mobile device and a fixed station. Radar systems for example measure the run-time of radio signals transmitted by a station and echoed by the station's environment. Time-of-flight cameras work in a similar manor typically transmitting and measuring infrared signals.

Satellite based positioning systems like GPS, Gallileo or alike, estimate the distance between a mobile station and satellite stations by measuring the receive time of signals transmitted by a respective satellite and determining the transmit time from data provided by the satellite. The difference between transmit and receive time, also called time-of-flight, is used to calculate the distance.

Advanced methods like “differential GPS” (DGPS), “carrier phase GPS” (CPGPS) or “real-time kinematic” (RTK) use the phase of the carrier signal to increase the position accuracy to about 10 cm. Methods are known which use several surrounding ground-based reference stations with known positions which calculate and transmit position correction data via a mobile communication system to the mobile device. These methods have in common with the plain satellite-based positioning methods, that they require a line-of-sight between the device which position is to be determined and 5 or more satellites or reference stations. This make the methods less appropriate for indoor positioning.

In mobile communication systems, positioning methods may be implemented. Measurements of signal strength on signals, whose transmit power is known, allow a rough estimation of distance while multiple receive antennas like MIMO antennas or antenna arrays may measure the angle of arrival of received signals.

Observed time difference of arrival (OTDOA) methods are often incorporated into cellular mobile communication systems. For OTDOA the mobile device measures the receive time of reference signals transmitted by multiple base stations. The receive time is dependent on the time of transmission and the time of flight or speed of light and the distance between mobile device and the respective station. With the knowledge of the relative transmit time of the base station, the relative distance can be calculated and by triangulation, the position of the mobile device can be estimated.

The OTDOA method as incorporated in known cellular communication systems like UMTS or LTE, uses time measurements on received reference signals. These reference signals can be signals sent by the base station for other purposes, e.g. for cell search or demodulation, or it can be signals that are dedicated for the purpose of position estimation. In both cases the reference signals confirm with the time-frequency-grid of the respective cellular system, i.e. they are using the system's slot configuration and the related symbol length in the time domain and the system's carrier spacing in the frequency domain.

The OTDOA method can also be performed with measurements on the uplink signals transmitted by the mobile device to multiple base station which determine the relative time difference of the received signals. The uplink signals are then similar reference signals confirming with the time-frequency-grid of the system's uplink resources. In aviation and other vehicles, distance measurement equipment is known that estimates distances from transmitted signals that are actively responded to by a receiver device to which the distance is to be measured. The time at which the response is received depends on the distance, the speed of light and processing time in the responder, see for example. EP 0 740 801.

In general, for a positioning method based on a time measurement of a received signal, the symbol duration of the symbols used for the signal influences the possible accuracy of the measurement. The shorter the symbol duration is, the more precisely the time instance of reception can be measured. According to the well-known physical dependencies, a shorter symbol has a larger bandwidth compared to a longer symbol with the same signal shape.

Increasing the accuracy of positioning methods incorporated into a cellular system will thus require signals to be transmitted which have a higher bandwidth and a shorter duration than compliant with the system's time-frequency-grid.

DE 102015013453 B3, also published as US 2018/0306913 A1, incorporated herein by reference for all purposes describes a relatively new method of measuring the distance between a mobile device and a fixed station in a similar way as described above. A first device (the device that transmits the first signal is called interrogator in the following text) transmits a signal that is very short in time. The signal is received by a second device (called transponder in the following text) and a response signal is transmitted. The distance determination in the first device takes into account the time difference between transmitting the interrogator signal and receiving the responds signal and the processing time in the transponder. In order to determine the processing time, the transponder transmits the response signal at one of distinct precisely defined time instances. With only few iterations of transmitting an interrogator signal and receiving the response, the fixed station can adapt the transmit timing so that from the time of receiving the response signal, an exact processing time can be derived and thus a very accurate time-of-flight calculation is possible. Based on the procedure described in that patent, the distance between the first and the second device can be estimated with a precision of as little as one centimetre.

In order to achieve this accuracy, the signals transmitted have to be very short and reliably detectable by the receiver, i.e. by demodulation in the respective receiver device with a suitable demodulation scheme. The modulation and short time constraints result in a large bandwidth of the signals.

To achieve an accuracy of the distance measurement of only a few centimetres for example, the signals need to be as short as 50 ns and the resulting bandwidth using a chirp signal shape is 100 MHz.

The positioning method of DE 102015013453 B3 can be deployed using a dedicated frequency spectrum, but as spectrum is a scarce and expensive resource and the signal is very short in time, an incorporation of the positioning estimation method in a cellular mobile communication system would be beneficial but has yet not been developed.

Air interfaces of known mobile communication systems like UMTS, LTE and 5G new radio (NR) support positioning methods like OTDOA triangulation which have an accuracy of several (tens of) meters. As explained above, the accuracy is linked to the length of the used reference symbols. A shorter signal will lead to an increased accuracy. Current methods use the same symbol length for such positioning signals as used for all other types of communication offered by this air interface. Therefore, the positioning accuracy is limited to the symbol length that is used by the air interface of the particular communication system. It is about 70 μs for LTE which enables a position accuracy of about tens of meters and it will be down to about 4 μs for 5G which may increase accuracy to about a few meters.

The known techniques do not provide a positioning method incorporated into or overlaid onto a cellular air-interface so that it uses the same carrier frequency but reference signals of length significantly below the air-interface symbol length. Thus, prior art does not provide such incorporation of positioning methods which have an accuracy of centimetres and that are flexible enough in using the cellular resources to not overly interfere with these resources despite a signal bandwidth far greater than the air interface's subcarrier bandwidth.

In the special case of a positioning system according to DE 102015013453 B3 or a similar system, the positioning method is based on a positioning signal as described above transmitted by an interrogator and responded to by a transponder with the same or a similar signal. The signal transmission and response may be repeated in multiple iterations to finally have an accurate estimation of the processing time used in the transponder and based on that, accurately determining in the interrogator the time-of-flight of signals and thus the distance between interrogator and transponder.

US 2009/0323596 A1 describes the scheduling of positioning channels between differing base stations taking into account network information such as a cell-ID of a UE or a list of base stations within range of the UE. US 2019/0208366 A1 describes the selection of transmission and reception points for the transmission of positioning reference signals. For sets of signal location parameters a cost function based on a UE-TRP distance is determined and used to select TRPs for further iterations of position estimation. US 2016/0183044 A1 describes a method for determining a UE's position using signals received from other UEs using device-to-device communication with measurement results being reported to an eNB for position determination based on signal attenuation. Transmission resources may be allocated such that they overlap with subframes of an adjacent cell which are muted.

It is thus the aim of the present invention to incorporate a positioning or distance measurement system into a cellular mobile communication system in a way that results in limited or no disturbance of the cellular mobile system while using the same frequency band for cellular communication and positioning estimation, whereas the duration of reference signals used for distance measurement is smaller than the duration of symbols used for communication. The positioning or distance measurement system incorporated is based on a wide band short time signal transmitted by one of the base stations and the mobile user equipment (UE) device and received by the respective other device (UE device or base station).

The present invention provides a method of allocating radio resources for the transmission of radio signals for determining a distance between a first station and a second station by transmitting a first signal in a first direction from the first station to the second station and a second, response signal in a second direction from the second station to the first station after a reception of the first signal at the second station, wherein a selection of a timing of the radio resources is made using a predetermined measurement of a distance between the first station and the second station.

Resources may be allocated to UEs such that signals from UEs to a base station are received without overlap and accordingly the processing of such signals is more straightforward.

The present invention allows the usage of high bandwidth measurement signals for high precision distance measurements in cellular communication systems. More specifically, this invention enables a high precision position estimation, so called position fixes, utilising first signals, so called “interrogator signals”, sent from a first station to a second station, and second signals, so called “transponder signals”, sent as response to the reception of the first signal from the second station to the first station, using cellular system resources efficiently. Even more specifically, the interrogator signals and transponder signals related to the position fix of a single device have a strict time relation, i.e. the position fix is based on that the transponder signal is transmitted shortly after or a short distinct time period after the interrogator signal is received by the second station. The proposed method is mainly a method for distance estimation. It can be used especially for high precision position estimations. This would require additional well-known measures, e.g. triangulation by using three or more distance measurements of the UE to different base stations.

As positioning is the main use case for the distance estimation, the procedure is named “positioning” in the following text. Therefore, the used signals are named “positioning signals”.

It is the aim of the present invention to multiplex short time high bandwidth positioning signals for successive measurements of the same or of different mobile (UE) devices onto the resources of the cellular communication system.

It is assumed that the same signal shape is used for all positioning measurements, i.e. for the first and the second signal and for different users. In other words, the signal shape does not allow a receiver to determine the originator of a signal unless the receive time correlates with a pre-defined or pre-known originator of the signal. Time duplexing is applied to distinguish the first and the second signal and time multiplexing is applied to distinguish different measurements. This invention therefore takes care, that at no time instance more than one measurement signal will reach any measurement receiver. This method allows using signals of very short duration, which require a bandwidth, that is much larger than the subcarrier spacing of the cellular system. For example, in LTE the OFDM-Symbol duration is 71 μs (which is also used for positioning reference symbols) and the system bandwidth can be up to 20 MHz. For comparing the method with the currently deployed LTE systems, a system using the same 20 MHz system bandwidth would lead to a signal duration of 0.25 μs, which is 285 times shorter and will lead to a 285 times better distance accuracy.

Multiplexing of user equipment, UE, devices on the cellular system resources is done by the base station on the basis of resource blocks. The resource grid in 4G and 5G systems, that is the time-frequency resource grid, is defined by resource elements and resource blocks. A resource element is the minimum discriminable grid element, i.e. a single OFDM subcarrier for the duration of a single OFDM symbol. Each symbol then carriers the binary information. The number of carried bits per symbol depends on the used modulation, e.g. 2 bit for QPSK and 8 bit for 256-QAM. The smallest piece of resource, that can be allocated to one UE device, is a resource block. One resource block in LTE comprises twelve OFDM subcarriers for a duration of a single slot consisting of six or seven OFDM symbols resulting in 72 or 84 resource elements per resource block. A resource block can be allocated to one UE device while an adjacent resource block, adjacent in time, i.e. the next slot, or in frequency, i.e. the next higher or lower twelve OFDM carriers, can be allocated to the same, another or no UE device. While a UE device is in general configured by the base station (eNB in LTE or gNB in 5G) via the radio resource control protocol (RRC) with the resources to use, i.e. the frequency band and possible modulation schemes, the actual usage of resource blocks is dynamically scheduled and allocated to UE devices dynamically via control channels. The DL physical control channel for example indicates with a UE specific identity sent on that channel, when data arrives on the following resource block of the DL shared channel. Also, UL resource blocks allocated to a UE are indicated on the DL physical control channel by the base station.

As the positioning signals of this invention are short in time in comparison to signals of the cellular communication system, this invention allows the efficient multiplexing of positioning signals of multiple UE devices within a single cellular system slot, or maybe even within a single cellular system symbol length. The present invention thus requires a new addressing and configuration of resources of sub resource block size.

Once resources of the cellular system can efficiently be freed from the cellular signals by not allocating them to any UE device in the respective cell for communication purposes but by allocating them to the present positioning procedure, it is an aim of the present invention to multiplex the high bandwidth short time positioning signals of multiple UE devices onto these resources in the most efficient way. This includes a selection of UE devices for which positioning is to be performed which are scheduled to use the freed resources for exchange of UE specific positioning signals. The selection may ensure signals of different UEs, sent by the base station or the UE device, are clearly distinguishable in the respective receiver, i.e. they cannot be mixed up with signals of other UE devices. The selection may take into account:
a rough time-of-flight estimation of signals between base station and the UE device (this is a different estimation than that used for positioning),
a positioning accuracy requirement for the UE device,
a requirement to perform repeated signal exchanges between the base station and the UE device, and
the availability of radio resources in the cell.

As set out above, the current available positioning signals provided by cellular systems use the same symbol duration for the positioning reference signals as used for transmission of communication data. As the duration of the used reference symbol is a limiting factor for the positioning accuracy, this invention enables the usage of reference symbols much shorter than the symbol duration used for communication. Therefore, this invention enables a much higher positioning accuracy, while it still offers the wide availability of a cellular communication system. It may even be possible, to provide indoor coverage of such positioning system, as small base stations which have implemented the invention will be of low price and could therefore easily be placed in many indoor positions e.g. small base stations in shopping centres or in manufacturing sites or home base stations at home. This will enable a scalable global indoor and outdoor positioning system of high accuracy, if required, and lower resource demand, if a lower accuracy is sufficient for the current application.

The present invention enables usage of positioning signals in cellular communication systems, that have a much shorter signal duration than the symbol duration of all other types of signals used for communication purposes in the systems.

A principle of the invention is the scheduling and allocation of radio resources by a base station to a UE device for position fixes,
the radio resources being generally used by a cellular system
for position fixes using wideband signals significantly shorter than the symbol duration of the cellular system,
the wideband signals consisting of interrogator signals sent from a first station to a second station and transponder signals sent from the second station to the first station in response to receiving the interrogator signal,
the first and second station being a base station or a UE device of the cellular communication system,
the location of the radio resources in time domain for a position fix of a first UE device being determined by the base station in dependence of a measure of distance between the base station and a second UE device,
the second UE device being allocated radio resources for position fixes time-wise before the first UE device,
the measure of distance being a measure of round-trip time of signals between the second UE and the base station, e.g. a timing advance (TA), or
the measure of distance being a previous position fix of the second UE device, potentially in combination with a time elapsed since the previous position fix,
the duration of the radio resources for a position fix being determined by the base station in dependence of a measure of distance between the base station and the first UE device, e.g. a TA or previous position fix of the first UE device.

Two alternative approaches exist for deployment of this common idea.

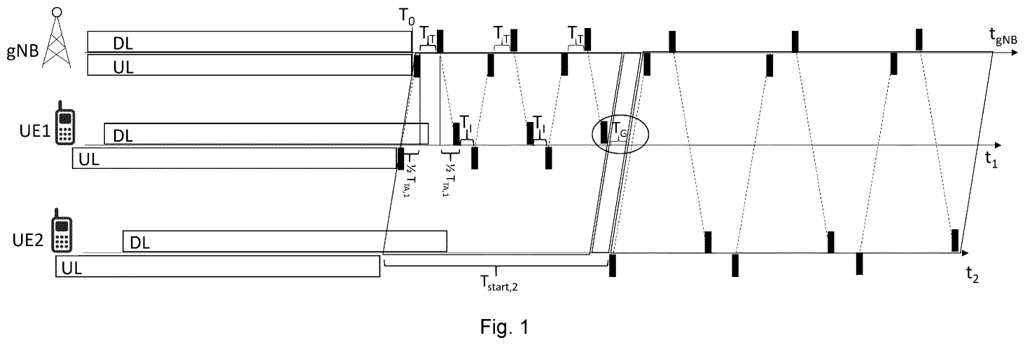

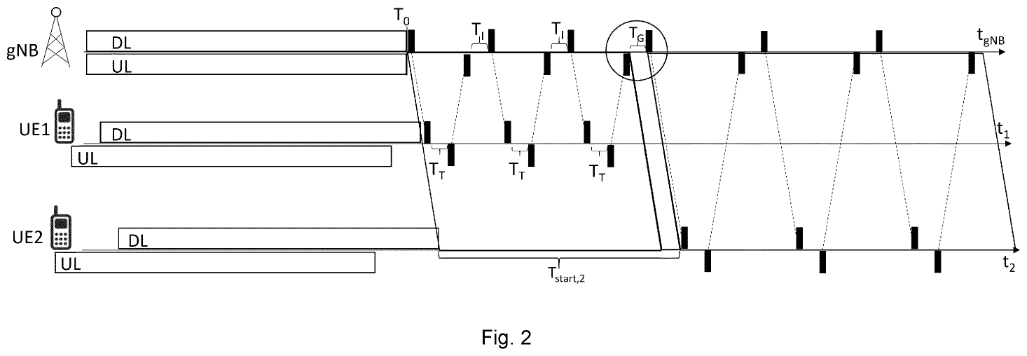

In a first approach, which is the most efficient approach regarding the configuration effort and which is described below with relation to FIGS. 1 and 2, a UE device is allocated with consecutive exclusive resources for position fixes for a period of time that depends on a measure of distance of the UE device, e.g. the TA or a previous position fix of the UE device.

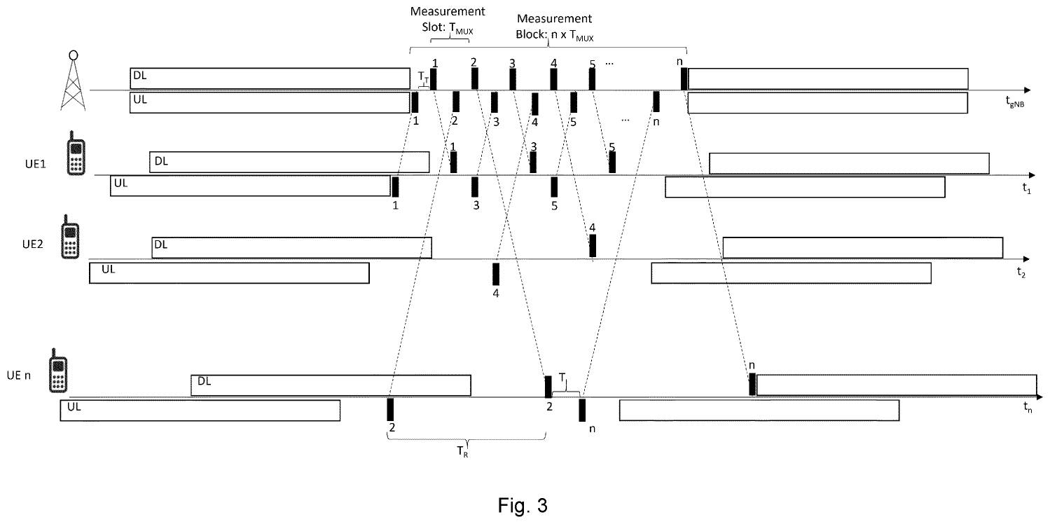

In a second approach, which allows an easier system implementation and which is described below with relation to FIG. 3, UE devices are generally allocated with exclusive resources for a pre-defined period of time that is common for a group of UE devices. The group consists of UE devices being successively allocated with radio resources for position fixes. In this approach, the group of devices is determined based on the UE device's individual measure of distance between the base station and the respective UE device.

Radio resources for iterative exchanges of interrogator and transponder signals between a base station and a single UE device for increasing the position fix accuracy with every iteration are allocated in a different way in the two approaches above.

In the first approach, radio resources for multiple iterative signal exchanges are allocated consecutively to a single UE device, i.e. the complete radio resources allocated to a single UE device consecutively have a length complying with the multiple signal exchanges, the length of resources for each single signal exchange being dependent on the measure of distance mentioned above.

In the second approach, radio resources for multiple iterative signal exchanges are allocated separately for each iteration with radio resources for each signal exchange being equally long for UE devices of the same group and their iterative signal exchanges, so called measurement slots. The positions of the measurement slots used for iterative signal exchanges being dependent on the measure of distance mentioned above.

In the first approach, the length of radio resources for position fixes of a UE depends on the UE's measure of distance, consequently the position or start of such radio resources of one UE device depends on the measure of distance of all UE devices previously scheduled for position fixes.

In the second approach, the position of resources allocated to a single UE devices or the time-wise distance of these resources depends on the UE device's individual measure of distance.

In both approaches it is an additional aspect of the present idea that the total amount of resources allocated to a UE device for a position fix depends on the number of position fixes requested or required by the UE device. In the first approach the length of the single consecutive resources allocated to one UE depends on the number of position fixes requested or required by the UE device, in the second approach the number of measurement slots allocated to a UE device depends on that same measure. It is an additional aspect of this invention to determine by the base station the number of positioning fixes required by the UE device from an accuracy required or requested for a positioning fix of the UE device.

In addition, the determination of the number of positioning fixes required by the UE device may be based on one or more past position fixes, an estimation of the UE device's velocity and/or a determination of a validity interval for the current position of the UE device taking into account the time elapsed since the last position fix.

The beneficial aspects of this invention are related to a base station allocating and configuring radio resources to one or more UE devices. Nevertheless, some aspects of the invention are related to a UE device being configured with and using the configured radio resources.

A UE may be enabled to transmit and receive positioning signals according to the configuration received from a base station and report the measured signal trip time to the base station, wherein the UE device requests radio resources for one or more positioning fixes from a network (the request comprising a requested positioning accuracy and/or a number of iterative signal exchanges for position fixes) and in response to receive from the base station a configuration of recurring measurement slots for exchange of interrogator transponder signals with the base station, the number of recurring measurement slots correlating with the requested positioning accuracy, number of iterations and/or a time of the previous position fix.

Preferred embodiments of the invention will now be described, by way of example only, with reference to the accompanying drawings in which:

FIG. 1 shows the transmission of location signals for two UEs where the UEs each act as an interrogator;

FIG. 2 shows the transmission of location signals for two UEs where the base station acts as an interrogator;

FIG. 3 shows the transmission of location signals for multiple UEs;

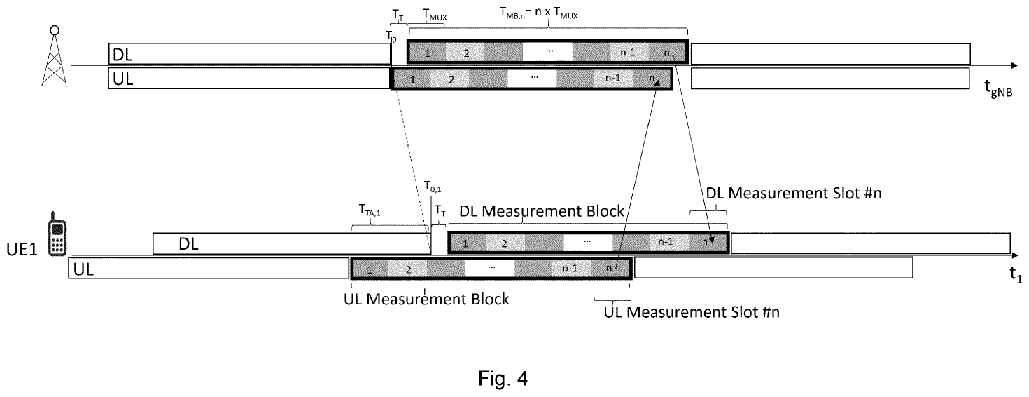

FIG. 4 shows the use of measurement time blocks for the transmission of location signals;

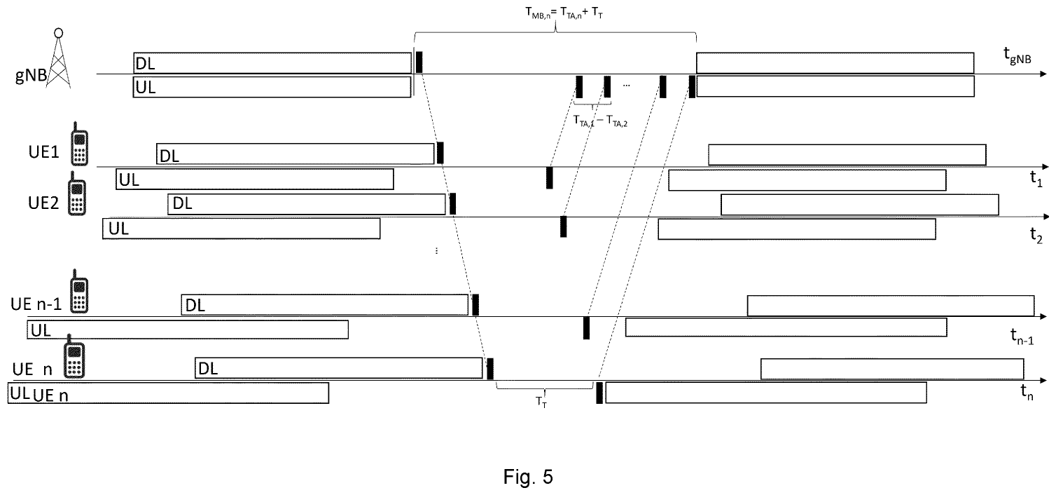

FIG. 5 shows an arrangement in which a base station acts as interrogator and transmits a single location signal for multiple UEs; and

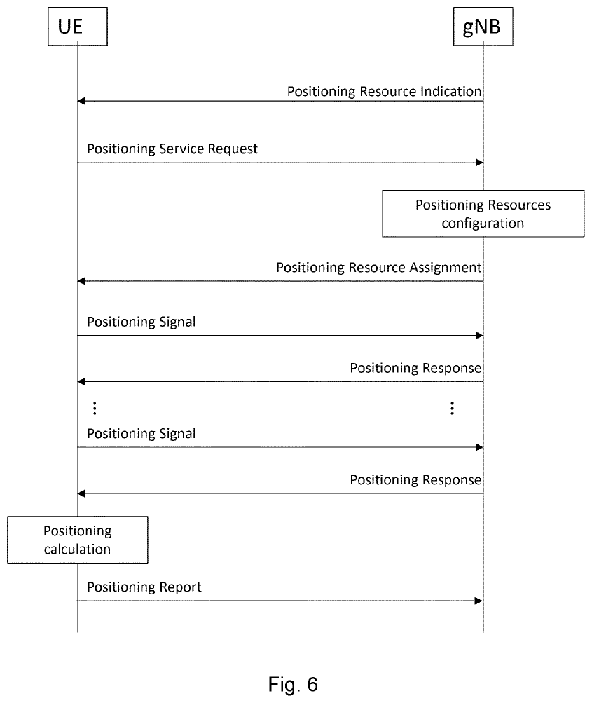

FIG. 6 is an event sequence chart showing an implementation of the invention.

A first solution for using freed cellular system resources for transmission of positioning signals related to positioning of different devices is to first allocate the resources solely to the positioning fix of a single UE device, following the first approach described above. In this solution, the first device maybe a UE device transmitting an interrogator signal to a second device which may be a base station. The resources are exclusively used by these two devices until the positioning fix of the UE device has been finalized. At that point in time, the resources can be used for positioning fixes of a second UE device then constituting the second UE device transmitting an interrogator signal.

In case the positioning fix of the first UE device comprises multiple iterations of interrogator and transponder signals being exchanged between the UE device and the base station, the resources may be used exclusively for these fixes consecutively until the position of the first UE device is determined. Only then, the cellular system resources are used for the second UE device, which again may comprise several iterations of positioning signal exchange. This case is shown in FIG. 1 with three iterations for each position fix between a gNB as a base station and two UE devices UE1 and UE2.

FIG. 1 shows UE1 to be significantly nearer to the base station (gNB) than UE2 which is evident from the time-of-flight of UL and DL signals, i.e. a shorter time difference between transmission of UL interrogator signals by UE1 and reception of the same by the gNB as well as between transmission of DL transponder signals by the gNB and reception of the same by UE1 than the respective time differences between UE2 and the gNB. The time-of-flight for UE1 is labelled as “½ T_{TA,1}” in FIG. 1 and explained in more detail in the following.

Also shown in FIG. 1 is that the UE devices transmit their signals, in this case interrogator signals, in advance of the base station timing. For example, the base station has scheduled resources for uplink transmission to UE1 at T₀. Now, UE1 uses these resources and transmits an interrogator signal in advance so that the signal is received at the base station at T₀. This is a basic principle of cellular mobile networks: The base station defines a common timing for a cell at the base station and mobile devices align to that base station timing. For that purpose, the UE devices get configured with an individual timing advance (TA) which constitutes a measure of distance between the base station and the UE device or in other words a measure of the round-trip-time of signals between the UE device and the base station. The TA is only a rough estimation configured with a step size of 0.5 micro seconds which equals around 75 meters (one-way) distance. The TA is depicted in FIG. 1 example wise for the first interrogator and transponder signals each travelling ½ of the configured TA of UE1 (T_{TA,1}).

The total time for each iterations of positioning signal exchange between UE1 and the gNB is thus dependent on the distance between UE1 and the gNB. To allocate positioning fix resource of the cellular system as efficient as possible, it is necessary to take the distance between UE1 and gNB into account when allocating positioning signal resources to UE2, or, in general, to take the distances and number of iterations of all preceding devices into account.

The exact distance is a result of the positioning fix and cannot a priori been taken into account for an allocation of resources before the position fix started. The granularity of the TA parameter as described above is on the other hand not sufficient to base a positioning fix solely on the TA, but for the resource allocation for position fixes of the current invention, it is an appropriate measure.

One aspect of the invention is to select and pre-configure radio resources for a second UE device by a base station, whereas the timing of the radio resources being dependent on a measure of the distance or signal round trip time between the base station and a first UE device, i.e. the first UE device being configured with radio resources time-wise preceding the second UE device's radio resources. The timing of the resources for the second UE device may also depend on the number of iterations of the second device's position fixes. In this, pre-configured means, that the configuration of all UEs that are scheduled for the same measurement block takes place before the first signal was transmitted within this measurement block (in contrast to a dynamic configuration of a second UE after the first UE finished its position fix). The pre-configuration may for example be done by the base station communicating to the respective UE device with a Radio Resource Control Protocol. In case that more than two UE devices should be scheduled within the same measurement block, the same principles apply: the timing of the radio resources for a UE device being dependent on a measure of the distance or signal round trip time between the base station and the UE devices that were scheduled with radio resources in the same measurement block time-wise preceding the resources of the considered UE device:
The resources for position fixes are allocated from resources otherwise used by the base station to serve a cell of a cellular network (for uplink, downlink or both).
The resources for position fixes are typically significantly shorter than the smallest resource part (e.g. “Resource Block” in LTE) that can be configured for a single UE device by the cellular system. In other word, resources for position fixes of multiple UE devices are allocated within a time interval that cannot be split in time between multiple devices by the cellular network.
The measure of the distance or signal round trip time as required for the resource configuration being, in one example, a timing advance (TA) of the first UE device.
In another example, the measure of the distance or signal round trip time as required for the resource configuration being one or more previous position fixes. A previous position fix being performed at any time before the resource configuration. The time between the previous and an anticipated current position fix may be taken into account for determining a current distance or round-trip time likelihood interval that is used to determine the timing of resources.
The timing of the radio resources being selected so that a position fix is finished comprising at least one signal round trip, i.e. a transmission of an interrogation signal by one of the gNB and the first UE device, reception of the same in the first UE device or the gNB, respectively, and subsequent transmission and reception of a transponder signal on the reverse path.

In case the interrogator is a UE device and the transponder is a base station as depicted in FIG. 1, the timing of the radio resources may be selected such that the last transponder signal transmitted from the base station to UE1 is never received by UE1 later than a potential and unintended reception in UE1 of the first interrogator signal sent by UE2 to the base station. The potential point where there is a risk of wrong signal timing is indicated with a circle in FIG. 1.

In the example case shown in FIG. 1, the resources allocated to UE2 for its first interrogator signal are allocated according to this invention such that they pass UE1 at least a guard time T_{G} after the last transponder signal is received by UE1. The position of the start of resources configure to UE2 T_{Start,2} with regards to T₀ in the base station is calculated for the three example iterations of UE1 as provided by equation (1):

$${T}_{Start , 2} = 3 \times {T}_{TA , 1} + 3 \times {T}_{T} + 2 \times {T}_{I} + {T}_{G} , \qquad ( equation 1 )$$

where

T_{Start,2} is the earliest time where resources can be configured to UE2 by the base station,
T_{TA} is the timing advance of UE1,
T_{I} is the time that elapses in the interrogator (UE1) between reception of a transponder signal and the transmission of an interrogator signal,
T_{T} is the time that elapses in the transponder between the reception of an interrogator signal and the transmission of a transponder signal, and
T_{G} is a guard time that prevents misinterpretation of received signals.

As evident from the formula, the start time of resources for UE2 is dependent on the TA value for UE1. The time that elapses between reception of signal and transmission of signal in the interrogator and transponder, T_{I} and T_{T}, may be an estimated constant value of processing time or it may be a systematic value that influences the position fix as in DE 102015013453 B3. However, in most realistic cases the influence of these values is negligible over the TA value. As a result, the adaption of the radio resources configured for position fixes of one UE device to TA values of other UE devices which previously performed position fixes with the same base station, significantly saves radio resources.

As described above, equation 1 is valid for the example case in FIG. 1, where three iterations are applied for the position fix of UE1. The formula for the start time of UE2 for the general case of a variable number of iterations “n” used by UE1 is:

$${T}_{Start , 2} = n \times {T}_{TA , 1} + n \times {T}_{T} + ( n - 1 ) \times {T}_{I} + {T}_{G} , \qquad ( equation 2 )$$

An ideal calculation of T_{Start,2} would require an addition of the signal width in time for each transmitted signal as also visible in the details of FIG. 1. As the signals are assumed to be of high bandwidth and to be very short in time in comparison to cellular system signals, this effect is neglected in this and all following equations. The technique may be applied equally taking this and further effects on the timing into account.

In case more than one other UE device perform a position fix before a UE device has resources for its fix configured, the timing of these resources according to this invention depend on the TA values of all the other devices and equations (1) and (2) would include additional portions for summing up the TA-based timing aspects and constant timing aspects of these UEs to calculate a resource start for the UE. Thus, the general concept described herein is the timing of resources allocated to a second UE device depending on the TA of one or more first UE devices.

The example with switched roles, i.e. the base station is the interrogator and UE devices are transponders, is depicted in FIG. 2 with a gNB as base station and two UE devices, UE1 and UE2. In this example UE devices are configured with resources on which they are prepared to receive interrogator signals from a base station in downlink. Being prepared also means that the expected signals were sent by the base station to the relevant UE device and not to other devices. The uplink resources for the transponder signal are time wise bound to the reception timing of the interrogator signal. In this example, the base station applies the timing to determine the point in time for transmission of first interrogator signals to UE devices and for reception of these signals by the UE devices, i.e to define and configure reception windows to UE devices.

The critical phase is marked with a circle in FIG. 2 where the base station ensures that interrogator signals are only sent after the last transponder signal is received. This ensures that interrogator signals intended for UE1 are not falsely interpreted by UE2. As shown in FIG. 2, the calculation of the time required for three iteration for a position fix of UE1 is in-line with equation (1) above. As again the biggest summand contributing to T_{start,2} is the TA of UE1, the step of configuring resources to UE2 dependent on TA of UE1 ensures an efficient resource usage in the system.

From FIG. 2 it can be assumed that the guard interval may be shorter than in the example from FIG. 1, as the aim of the guard interval here is not to avoid ambiguity between identical signals from different sources with uncertain timings, but to avoid simultaneous reception and transmission of signals. It may even be omitted, i.e. the transmission of the interrogator signal can start immediately after reception of the transponder signal. T_{G} may even be negative; in which case the base station transmits the interrogator signal for UE2 before the transponder signal of UE1 has been received but still significantly after the last interrogator signal for UE1 was transmitted. For most base stations it is also beneficial to ensure that the transponder signal will not be received by the gNB at the same time as the interrogator signal is transmitted, as the reception at the gNB will be interfered by the transmitted signal. Further, the base station has to ensure that the transmission time corresponds to the reception window configuration of UE2 and it is selected so that a clear identification of the correct interrogator signal is possible in UE2. It is important to note that nothing in this invention prevents the guard interval of length T_{G} and the constant or dynamic processing times T_{I} and T_{T} to be selected in different ways than described in this invention or even omitted.

It is evident from FIG. 2 that an imaginary third UE device UE3 that is not shown in the figure will be configured according to this invention with resources whose timing depends on the TA of UE1 and on the TA of UE2 which is much greater than that of UE1 due to its larger distance to the base station. The occupation time of the resources for UE2 for a position fix is thus greater than that of UE1.

It is thus another aspect of this invention to select the UE devices that want to perform position fixes consecutively within contiguous cellular system resources that have a certain timely dimension such that resource occupation of multiple distance measurements fits the timely dimension of the cellular system resources in an optimal way by considering the current TA values of each involved UE. In this way, the base station uses the cellular system resources most efficiently.

FIG. 3 shows another alternative of the present invention in alignment with the second approach described further above. The figure shows again an example where UE devices are interrogators and the base station is the transponder. Again, the grey areas of the carrier are occupied by the cellular system while an interval in time is free of cellular system usage for position fixes of multiple devices.

The scheduling of positioning resources by the base station in this example is performed with a grid pattern of fixed length T_{MUX} which we call measurement slot. The full interval that is available for position fixes, called measurement block, contains multiple measurement slots of the fixed length T_{MUX}. Now, it is the aim of this aspect to provide UE devices with resources for repeated interrogator and transponder signals and use the cellular system resources as efficient as possible.

As evident from FIG. 3 and also explained in relation to former use cases, depending on the distance between the respective UE device and the base station, the round trip time (labelled as T_{R} for UEn in FIG. 3), i.e. the time between transmission of an interrogator signal and the respective reception of the response signal varies. That is, a single iteration of a position fix requires a time that depends on that distance, which can be determined again from the TA of the UE device.

Thus, an aspect of this invention is a base station enabled to allocate recurring resources for position fixes to UE devices, whereas the time between recurring resource allocations to a specific UE device being dependent on the TA of this UE device. The resources available for position fixes of all UE devices may be divided between individual UE devices in slots (measurement slots) of fixed duration T_{MUX} and the individual UE device's measurement slot occurrence frequency depends on the UE device's TA.

This aspect is depicted in FIG. 3 where a measurement block is divided into n measurement slots each allocated to a UE device of the cell. UE1 is allocated the first measurement block and UEn the second. The distance between UEn and the base station is significantly larger than the distance between UE1 to the base station. Therefore, as evident from FIG. 3, UE1 gets allocated three measurement slots within the first five measurement slots, while UEn is only allocated a single measurements slot in that time interval.

The segmentation of the measurement resources according to the example of FIG. 3 is depicted in more detail in FIG. 4. The measurement block is segmented in n measurement slots of equal duration T_{MUX}. T_{MUX} is selected to be sufficiently long to avoid inter-symbol interferences (ISI), i.e. that a signal assigned to a certain slot is received in an earlier or later slot. Therefore, T_{MUX} is selected to be the timing advance step size ΔTA, as this is larger than the average timing error (½ ΔTA). This ensures that ISI is avoided as the signals will reach the receiver within the measurement slot even if the TA was calculated with an error of up to ½ ΔTA. The beginning of the measurement block depends on the device type, i.e. whether it is a UE device or a gNB, and on the function of the resource, i.e. whether it is for transmission or for reception of the positioning signal. As depicted in FIG. 4, the UL measurement block at the gNB starts at the reference time T₀ and the DL measurement block about T_{T} later, as this is the duration which is required to generate the response after reception of the interrogator signal. At UE1, the DL measurement block starts about T_{T} later than the experienced DL reference time T_{0,1}. The UL measurement block for UE1 start about the timing advance (T_{TA,1}) of UE1 earlier than T_{0,1}. This is the well-known method to make the reception at the gNB synchronous.

The above considerations assume transmission conditions that will not alter the signal duration at the receiver. In a typical mobile communication environment, the received signals will suffer from the multi-path effect. That means, that the transmitted signal will be reflected by objects and the received signal is an overlay of signals from different paths. This effect is increasing the received signal duration. To avoid ISI in the gNB of received symbols assigned to neighbouring measurement slots, this invention proposes to add the maximum delay spread to the measurement slot duration T_{MUX}.

Another issue with the delay spread occurs, when a UE is listening to a measurement signal from the gNB and it will receive any measurement signal sent by another UE, that was intended for the gNB. This issue is more likely in situations with high delay spreads, i.e. for UEs, that are far away from the base station. But also in cases of low delay spread this issue may occur to UEs which time-wise distance of the assigned measurement slots is equivalent to the signal trip time between these UEs. To avoid this issue, this invention proposes in one deployment to use different, orthogonal signal types for the UE and for the gNB that are distinguishable when received simultaneously, i.e. one interrogator signal type and one transponder signal type. In this case the signals from the UEs and the gNB could be distinguished and a mix up is avoided. An example of such signals could be a chirp sequence with time-wise increasing frequency for interrogator signals and the chirp signal with time-wise decreasing frequency for transponder signals. Other signals are of cause not prevented by this invention.

A related aspect is a UE requesting resources for a certain number of iterations for positioning fixes or recurring measurement slots from the base station and the base station configuring the UE device accordingly.

Another aspect is a base station, which predicts a positioning measurement uncertainty for a UE device from positioning fixes and the time that passed since these fixes have been performed and determines a number of required iteration for a next position fix from that past information followed by a transmission of a resource allocation for the determined number of measurement slots with a periodicity or frequency of measurement slots dependent on the TA of the UE device.

A procedure and message flow to perform the positioning measurement is depicted in FIG. 6 which shows the following:

0. Prerequisite: It is assumed, that the cellular network (e.g. the gNB) is enabled for the positioning method and has therefore means to select resources for positioning. How these resources are selected is not part of this invention.

1. The network has selected resources for positioning reference signals, e.g. periodically occurring measurement blocks of which parts could be assigned to different UE devices. These resources will be unused in uplink and downlink direction by all signal types of the cellular system except of positioning signals. The gNB transmits a message throughout the cell to all UE devices (e.g. broadcasted as part of the System Information), to inform the UE devices about these reserved resources, i.e. their position in time and frequency. This information is used by the UE devices to prevent measurements other than for positioning purposes within these resources, as the relating reference signal e.g. for RSRP measurement are absent. Further, the UE devices are aware, that Positioning Reference Signals are present upon request in this cell. Even further this information will prevent the UE devices from transmitting or expecting any signals other than positioning signals, e.g. in case it has recurring resources for communication (“semi-persistent scheduling”).

In a very efficient embodiment, the guard period of the “special subframe” of a TDD System is used as positioning measurement block. This is beneficial, as it requires no additional signaling to blank the resources from other signal types, as they are already blank.

Another efficient method for the 5G cellular system is, to define a bandwidth part for such positioning signals.

2. UE1 requires position fixes for autonomous driving. Therefore, it requests a positioning service by transmission of a “positioning service request” message to the network. The request includes further details like required positioning accuracy, frequency of position fixes, etc. In this example it requests an accuracy of about 1 m and a frequency of 1 position fix per second. In addition (not shown in FIG. 6) a further UE transmits a positioning service request to the gNB.

3. The gNB receives positioning service requests from multiple UEs.
a. The gNB determines a positioning method, i.e. whether UEs should be interrogator or transponder and whether the signals of different UEs are interleaved (second approach, cf. FIG. 3) or not (first approach, cf. FIG. 1). For the determining, the gNB considers the TA values of the requesting UEs and/or potentially previous position fixes.
It may, for example, select the method “UE is the transponder” in case the maximum TA value is higher than the duration of the measurement resource (this avoids interferences with the following DL symbols) and may select “UE is interrogator” if many UEs have almost identical TA values.
It may select the non-interleaved option if most UEs are moving fast or require a very high accuracy, as in this mode the accuracy and the tolerance for changing signal trip times is higher.
b. It selects suitable UEs from the current set of requesting UEs. Also, for this selection the TA values are considered. It may for example select UEs according to one or more of the following rules:
   i. The largest TA value is smaller than the duration of the measurement block, if “gNB is interrogator” is the selected method.
   ii. The smallest difference in TA values between any two selected UEs is ≥2 ΔTA, if the method according to FIG. 5 is selected.
   iii. The sum of all scheduled measurements fits into the available measurement block, if the method according to FIG. 3 is selected
   iv. If successive measurements (Iterations) are scheduled for a UE within one measurement block, they fit into the measurement block.
c. The gNB configures the requested resources, i.e. it assigns measurement slots to the UEs in case of the methods according to FIGS. 1 to 3, or it derives a list of the UEs in order of increasing individual TA, if the method according to FIG. 5 is used.

4. The gNB transmits the selected resource configuration to the UEs, i.e. which frequency, bandwidth and time instances to be used for listening to and transmission of the positioning signals, and which role the UE should use (interrogator or transponder)

5. The UEs perform the transmission and reception of the positioning signals according to the received configuration. In case it was assigned to the role as interrogator, it starts to transmit a positioning signal (as depicted in FIG. 6). Otherwise it starts to receive the positioning signal transmitted by the gNB (not depicted in FIG. 6).

6. The gNB performs the transmission and reception of the positioning signals according to the configuration.

7. If the UE is the Interrogator, it calculates the signal trip time from the transmitted and received positioning signals and reports the derived signal trip time to the gNB.

8. If the gNB is the Interrogator, it calculates the signal trip time from the transmitted and received positioning signals.

9. The gNB calculates the position of the UEs. It uses the results from step 7 or step 8 and additional information according to the selected positioning method (e.g. via triangulation with signal trip times towards other gNBs or via estimation of the angle of arrival, etc.)

10. The gNB reports the UEs position to the relating device. This may be the UE that relates to the derived position or any other device, e.g. a network entity which requires or forwards the UE's position information.

A very resource-saving embodiment is depicted in FIG. 5. In this example, the gNB is the interrogator and the UE devices are transponders. The gNB is transmitting a single positioning signal, which is intended to be received by all UE devices that are currently using the positioning service. Each UE device is responding to this signal. The responses will reach the gNB at different time instances, according to their individual distance to the gNB, e.g. their TA-values. For this embodiment it is essential for the gNB, to select the UE devices responding to a single interrogator signal from the base station according to their TA values. None of the selected UE devices should have an identical TA value than another selected UE device. This will ensure that the responses will not interfere with each other. To consider the timing inaccuracy of the TA value, the minimum distance between each of the selected UE devices should be 2 times the TA step size ΔTA, i.e.

$${TA}_{x} - {TA}_{x - 1} \geq 2 \times Δ TA . \qquad ( equation 3 )$$

This timely distance is shown in FIG. 5 for the first and the second response.

For easy mapping of responses to the related UE devices, the gNB will list the involved UE devices in increasing order according to their TA values, i.e. the first listed UE has the lowest TA, the second listed UE device the second lowest TA, and so on. The received responses are then mapped by the gNB to the UE devices according to the reception order: the first received response is mapped to the first listed UE device, the second received response to the second listed UE device, and so on until the last response was mapped to the related UE device. The listing of UE devices in this embodiment is only used for ease of understanding and should not restrict any other implementation option.

This embodiment is beneficial, as no UE device specific scheduling has to be transmitted to each UE device. Instead, the UE devices as selected by the base station are configured to reply to the same specific interrogator signals. There are several ways how to implement such a configuration. One example would be to pre-configure UE devices in groups and configure a group identification (ID) to the respective UE devices. On the cellular DL control information, the base station then indicates the group or groups that is/are to reply to interrogator signals on specifically scheduled resources.

This principle requires only a very low duration from the resources for the interrogator signal and the transponder signals, which is defined by the TA value of the farthermost UE device, i.e. this embodiment is most resource efficient for scenarios, were the UE devices are distributed in the centre of the cell (Note: the UEs must still fulfil the equation 3, i.e. should have different distances to the gNB).

In this embodiment the common core of the invention is used in the grouping of UEs collectively replying to a single interrogator signal and the mapping of incoming responses in the order of a UE device individual measure of distance to the base station, e.g. a TA. The grouping on the base of the measure of distance is configured to the UE devices and due to the minimum difference of distance or TA, the grouping constitutes an allocation of UL resources for a transponder signal in relation to the point in time of transmission of the interrogator signal by the base station.

The mapping of the transponder signal receive time to individual UE devices constitutes an allocation of radio resources of a UE devices which configuration is used in the base station.

Both, the grouping of UE devices and the mapping of UL resources in the base station are performed in dependence on the measure of distance of the respective UE devices but also in dependence of other UE devices (in the same group), as described above.

1. A method of allocating radio resources for the transmission of radio signals for determining a distance between a first station and a second station by transmitting a first signal in a first direction from the first station to the second station and a second, response signal in a second direction from the second station to the first station after a reception of the first signal at the second station, wherein a selection of a timing of the radio resources is made using a predetermined measurement of a distance between the first station and the second station.

2. The method according to claim 1, wherein the selection of the radio resources comprises at least one of a selection of a location of the radio resources in a time domain and a selection of a duration of the radio resources for transmission of at least one of the first and second signals.

3. The method according to claim 1, wherein the selection of the radio resources depends on the distance between first station and the second station and a previously determined distance between a third station and one of the first and second stations.

4. The method according to claim 1, wherein the predetermined measurement of a distance between the first station and the second station is obtained from a timing advance parameter determined for a radio connection between the first station and the second station.

5. The method according to claim 1, wherein the first station is a base station and the second station is a user equipment, UE, device.

6. The method according to claim 5, wherein the second station is a first UE device and wherein the method further comprises allocating radio resources for the transmission of radio signals for determining a distance between the first station and the second UE device, and wherein the base station timings of radio resources for the first UE device and for the second UE device dependent on predetermined measurements of distances of the first and second UE devices to the base station.

7. The method according to claim 6, wherein the base station allocates radio resources to enable multiple first and second signals to be transmitted between the base station and the first UE device in a first time window and the base station allocates radio resources to enable multiple first and second signals to be transmitted between the base station and the second UE device in a second time window, the second time window being after the first time window.

8. The method according to claim 7, wherein the first time window has a duration which is dependent on the predetermined measurement of distance between the base station and the first UE device.

9. The method according to claim 7, wherein second time window has a duration which is dependent on the predetermined measurement of distance between the base station and the second UE device.

10. The method of claim 6, wherein the predetermined measurements of the distances of the first and second UE devices to the base station indicate that the distances are within a first range and distances between one or more further UE devices to the base station are within a second range and wherein radio resources are allocated to the first and second UE devices with a first time window and radio resources to the one or more further UE devices in a second time window.

11. The method according to claim 1, wherein a predictive algorithm is used to predict a positioning measurement uncertainty for a UE device from previous positioning measurements and a time measurement and to determine therefrom a number of iterations required to obtain a new positioning measurement for that UE device and to allocate radio resources required to enable the number of iterations to be performed.

12. The method according to claim 1, wherein the first and second signals are transmitted with a signal duration less than a symbol duration for data communication between the base station and the respective UE device.

13. The method according to claim 1, wherein the first and second signals are used to determine a separation between the first station and the second station as a step in determining a position of the UE device.

14. The method according to claim 2, wherein the selection of the radio resources depends on the distance between first station and the second station and a previously determined distance between a third station and one of the first and second stations.

15. The method according to claim 2, wherein the predetermined measurement of a distance between the first station and the second station is obtained from a timing advance parameter determined for a radio connection between the first station and the second station.

16. The method according to claim 2, wherein the first station is a base station and the second station is a user equipment, UE, device.

17. The method according to claim 8, wherein second time window has a duration which is dependent on the predetermined measurement of distance between the base station and the second UE device.

18. The method according to claim 2, wherein a predictive algorithm is used to predict a positioning measurement uncertainty for a UE device from previous positioning measurements and a time measurement and to determine therefrom a number of iterations required to obtain a new positioning measurement for that UE device and to allocate radio resources required to enable the number of iterations to be performed.

19. The method according to claim 2, wherein the first and second signals are transmitted with a signal duration less than a symbol duration for data communication between the base station and the respective UE device.

20. The method according to claim 2, wherein the first and second signals are used to determine a separation between the first station and the second station as a step in determining a position of the UE device.
